(19) United States
(12) Patent Application Publication
(10) Pub. No.: US 2010/0287054 A1
(43) Pub. Date: Nov. 11, 2010

(54) System And Method For Integrating An Ad Banner With A Calling Application

(76) Inventors: Shai David Zohar, Tel Aviv (IL); Ido Eli Zohar, Tel Aviv (IL)

Correspondence Address: The Law Office of Michael E. Kondoudis, 888 16th Street, N.W., Suite 800, Washington, DC, 20006, US

(21) Appl. No.: 12/812,241

(22) PCT Filed: Jan. 8, 2009
(86) PCT No.: PCT/IL09/00032

§ 371 Date: Jul. 9, 2010

Related U.S. Application Data
(60) Provisional application No. 61/006,379, filed on Jan. 10, 2008.

(51) Int. Cl. G06Q 30/00

(52) U.S. Cl. 705/14.72

(57) ABSTRACT

A method, a system and a module method of creating enhanced banners, each comprising content and functionality of an original ad banner (e.g. rich media file) and a calling application enabling users to initiate a call with an advertiser, associated with the original and enhanced banners. The system, module and method may enable integrating the original code and content of said original banner with the calling application; and creating a new enhanced banner, which is a new RMF enabling the combined operative functioning and content of the calling application and the banner, where the new created enhanced banner enables a user to initiate a call between the advertiser and the user by operating the calling application in the enhanced banner.

### CROSS REFERENCE TO RELATED APPLICATION

This application claims the benefit of U.S. Provisional Patent Application 61/006,379, filed Jan. 10, 2008, which is incorporated herein by reference in its entirety.

### BACKGROUND

1. Field of the Invention

The present invention generally relates to the field of ad banners of rich media files and more particularly to methods and systems for integrating ad banners with calling applicability.

2. Related Art

Ad banners usually comprise media content data such as text, animation (Flash), video and/or audio content data. Most ad banners are managed by one or more servers and can be embedded in one or more network pages of different websites.

Advertisers such as services and products providers often use banner for advertising their services and/or products online by enabling users, using one network page or a website, where an ad banner is published, to enter (link) to the advertiser's website or network page, view more information relating to the advertiser and/or purchase products and/or services by clicking on the ad banner's designated virtual purchasing button, for example.

Advertisers and other services providers often try to achieve direct communication with the user by allowing, for example, to enter his/her communication details such as phone number—for communicating with the user by calling him/her, email address for sending advertising emails, internet protocol (IP) address for communicating with the user through online call services and protocols such as voice over IP (VoIP) etc.

Ad banners with calling tools are also provided enabling the user to click a designated area in the banner in order to initiate a call (such as a VoIP call) between the advertiser and the user.

Patent Application No. US2007100956 (A1) (referred to hereinafter as “the application”), provides system and method for more telephone call based pay-for-performance Internet advertising. This application allows callers to connect to advertisers over the telephone by just a single click from a generally distributed Internet-based advertisement, by providing the capability to efficiently track precisely from which channel, of a multiplicity of Internet-based distribution channels, a unique advertiser's advertisement attracted an incoming call, and by providing a simple set pricing structure for advertisers and a complex, behind-the-scenes, combination of category, keyword, random selection and historical experience for priority display of advertisements (see Application US2007100956 (A1), Abstract).

The application enables facilitating the creation of a unique batch of computer code, a ‘single-click’ call activator link, for the advertiser that is embedded into the advertiser's unique Advertisement (see Application US2007100956 (A1), paragraph [0061]).

The application enables creating an advertisement page (such as a network page) with an added calling link, which enables the activation of calls to the user.

### BRIEF SUMMARY

The present invention, in some embodiments thereof, provides a system, a method and a module for creating enhanced banners by integrating at least one original ad banner, which is a rich media file (RMF) with a calling application.

According to some embodiments of the invention, the system, module and method may enable integrating the original code of the original banner, comprising media content of one or more types and may also comprise code related to functionality of the ad banner (e.g. commands), with a code of the calling application and other graphical and operative functions (e.g. dialing function, client data storage, supervising code for supervising the created enhanced ad banner with the calling applicability, etc.); and creating an enhanced banner, which may be a new RMF, enabling the combined operative functioning of the calling application and the banner such as the graphical and operational aspects of the banner and the initiation and execution of calls between the user and the advertiser (e.g. through VoIP applicability, calls between telephones (cellular or wired) of the advertiser and user and the like.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a flowchart schematically illustrating a method for integration an ad banner with at least one calling application, according to some embodiments of the invention;

FIG. 2 is a block diagram, schematically illustrating a system for creating combined rich media files enabling to integrate an ad banner with a calling application, according to some embodiments of the invention;

FIG. 3A is a diagram, schematically illustrating an integration module enabling to integrate content of an original banner with a calling application and a supervision code, using a dynamic container, according to some embodiments of the invention;

FIG. 3B if a flowchart, schematically illustrating a method enabling to integrate content of an original banner with a calling application and a supervision code, using the dynamic container, according to embodiments of FIG. 3A;

FIG. 4 is a flowchart, schematically illustrating a process in which the original code of an original ad banner is integrated with a calling application code by de-compilation the code of the original banner and recompiling the integrated codes, according to some embodiments of the invention;

FIG. 5A is a diagram, schematically illustrating an integration module for integrating the original banner as an embedded slave in a master container, according to some embodiments of the invention;

FIG. 5B is a flowchart, schematically illustrating a process for integrating the original ad banner as an embedded slave in a master container, according to embodiments of

FIG. 6 is a flowchart schematically illustrating a process of customizing and adding a calling functionality to an ad banner utilizing a plug-in software and an advertiser account, according to some embodiments of the invention; and

FIG. 7 is a diagram, schematically illustrating a main banners module, enabling to receive multiple original banners from multiple third and first party entities, integrate them with a calling application and return a resulting enhanced banners, according to some embodiments of the invention.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTION

The present invention, in some embodiments thereof, discloses, a system 1000, a main banners module and a method for integrating the code of a rich media files (RMF) such as an advertisement banner (an ad banner) with a calling application, where each the banner is associated with at least one advertiser.

According to some embodiments of the invention, the integration may create a new rich media file (e.g. a new enhanced banner) comprising at least parts of the original banner, a “calling-code” enabling calling applicability and functionality and a “supervision code” allowing the new output file (the enhanced banner) to supervise and control the content of the new enhanced banner originating from the content of the original banner and the way the original code of the original banner is combined into the enhanced banner.

According to some embodiments of the invention, the resulting new enhanced banner may be a “ready-to-be-published” banner, where the new enhanced banner may enable all the operational, graphical and display features of the original banner with the additional functionality and display features enabling a user, inter alia to execute calls between the advertiser and the user through the new enhanced banner by, for example, clicking or double clicking a virtual calling button in a virtual bubble or a virtual folded corner whereby a call is executed automatically communicating the advertiser with the user (e.g. on the expense of the advertiser).

According to some embodiments of the invention, the calling application added to the advertiser's original banner may enable advertiser to communicate with users through (i) various communication networks, (ii) various formats, (iii) various users' terminal devices (e.g. PC, laptops, mobile phones, phones etc.) and (iv) various communication protocols (e.g. VoIP communication, wireless communication, public switch telephone network (PSTN), etc.).

According to some embodiments of the invention, the calling application may initiate an automatic callback option whereby a communication system initiates a call back to the user's terminal (e.g. to through the terminal's phone number, SIP or IP address) and connect the call with advertiser. For example, the converted new enhanced banner may display a bubble in the display area (stage) of the enhanced banner with input fields that should be filled by the user enabling the user to input communication and personal input such as the user's phone number, IP address or any other communication identifier. As the user selects the call (e.g. by clicking upon a virtual button) a communication system may automatically initiate call both to the advertiser's communication terminal and to the user's terminal (e.g. via VoIP or via a wireless/wired communication) and then connect the call as known in the art.

According to some embodiments of the invention, a predefined program code embedded in the new RMF (which may be a new output banner with the calling application) may enable supervising, controlling and managing the display and operative functionality of said new RMF enhanced banner features. The graphical and operative functionality of the new RMF may include the managing of the original banner's media content and interface operations as well as execution of calls through the new RMF.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

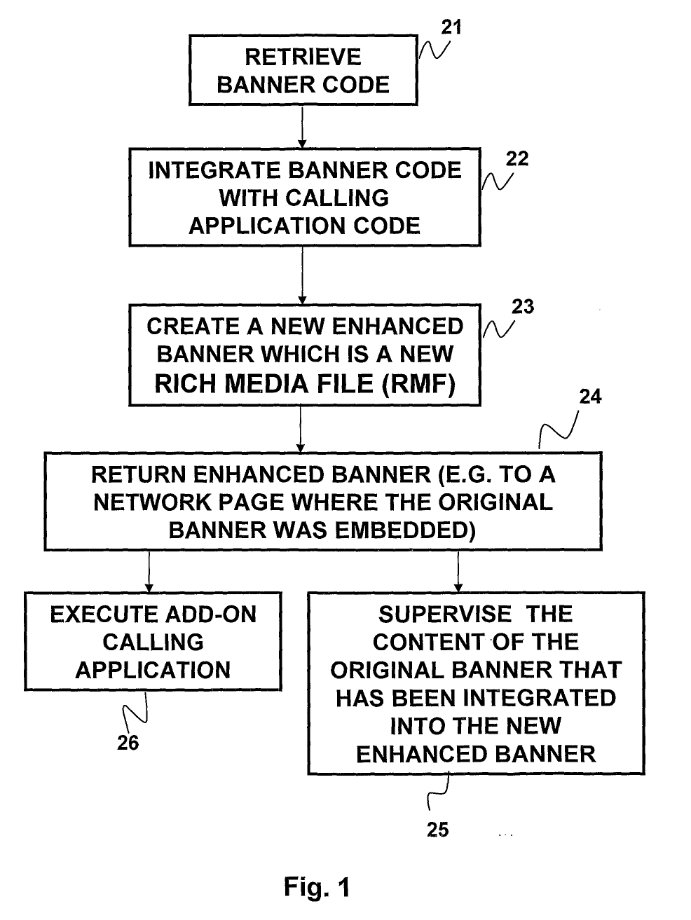

FIG. 1 is a flowchart, schematically illustrating a method for integration and supervision of an original ad banner 10′ with at least one calling application, according to some embodiments of the invention. The method may comprise:

retrieving the original code of the original ad banner 21 (e.g. through a main website);

integrating the original code of the original banner 10′ (e.g. content and scripts) with a calling application 22 and other graphical and operative functions;

creating a new RMF, which is a new enhanced banner 23 enabling the combined operative functioning of the calling application, the original banner 10′ and other functions, where steps 22 and 23 provide the conversion of the original banner 10′ into a new enhanced banner 10 RMF;

embedding the newly created RMF in at least one network page 24;

supervising and controlling the original banner content and code 25 in parallel to executing the newly added calling application 26 in the newly created output file, where the system 1000 may allow operating the new file as a new banner added with the calling applicability; and

executing a call between the user and the advertiser according to predefined execution settings, whenever the user initiates a call using a calling interface of the calling application integrated in the enhanced banner 10.

According to some embodiments of the invention, retrieving banner code may include uploading the original banner 10′ through the a network such as the internet to the system 1000 and, embedding the new RMF enhanced banner 10 in a network page 50 may include downloading the enhanced banner 10 RMF through the network from the system 1000 prior to embedding it in the network page 50. According to some embodiments of the invention, the calling application may allow executing calls to establish communication between a users' terminals such as, for example, personal computers (PCs), laptops, cellular phones etc., as known in the art, through any type of communication network, including but not limited to network known in the art such as, for example, the Internet, intranet, wireless communication networks etc. as known in the art.

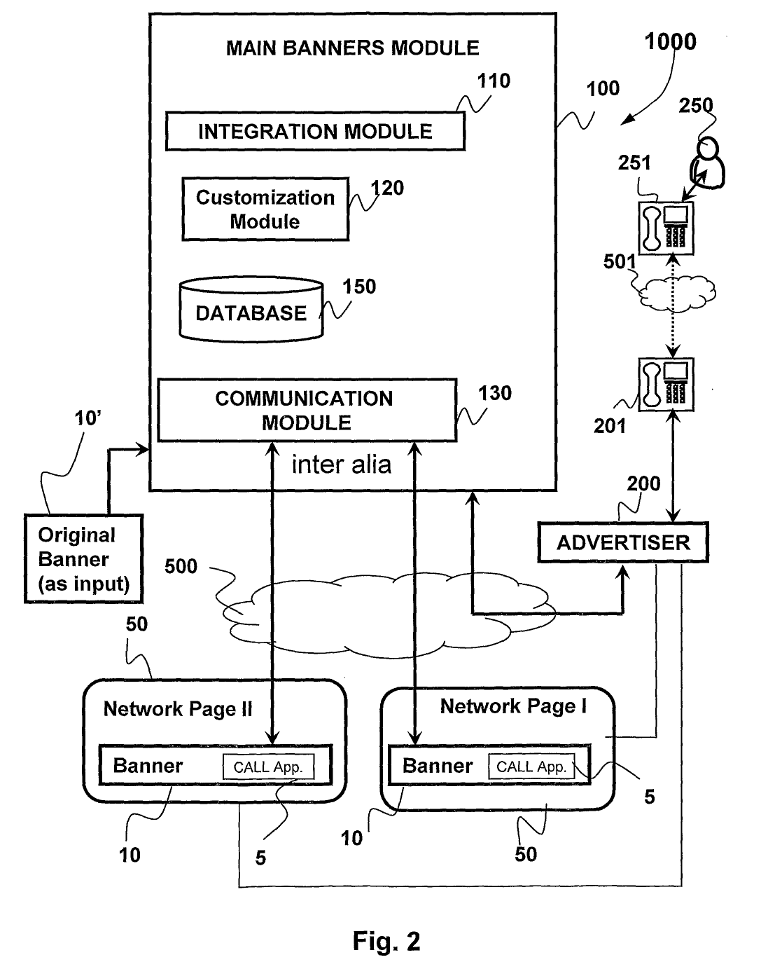

FIG. 2 schematically illustrates the system 1000 for creating combined rich media files enabling to integrate an original ad banner 10′ application with a calling application 5, according to some embodiments of the invention.

According to these embodiments, the system 1000 may comprise at least one advertiser's terminal 201, which may be any communication and/or computerized device, associated with an advertiser 200; at least one user's terminal 251, which may be one or more communication and/or computerized device associated with at least one user 250; a main banners module 100 and one or more network pages 50.

According to embodiments, the main banners module 100 may enable integrating the original banners 10′ with the calling applications 5 as well as with a supervision code enabling to supervise over the code of the original banner 10′ and the way the original code of the original banner is combined into the enhanced banner.

According to embodiments, as illustrated in FIG. 2, the main banners module 100 may comprise at least some of:
an integration module 110 enabling to receive the code of the original banner and integrate it with a calling application code creating a new RMF enhanced banner comprising the combined operational functionalities and content of the original banner and the calling applicability;
a customization module 120, which may include a user interface enabling the advertiser 200 and other users to customize the calling application 5 of their enhanced banners 10 (e.g. by inputting calling identifier(s) such as the advertiser's 200 phone number(s), IP address for VoIP communication etc, defining graphical parameters of the calling application and functionality parameters and/or conditions of the calling application such as available calling hours and days of the week etc.).
a communication module 130 managing the communication of the new enhanced banner 10 with the system 1000, definitions (e.g. made by the advertiser 200 regarding the calling application) and recording (e.g. storing information of the calls executed and the network page 50 from which the execution is carried out, web redirections originated by the original banner content, the caller's IP address and phone number etc.), where communication may be initiated through any type of communication network, including 500 currently or future known in the art; and
at least one database 150 enabling to store and search for information regarding the original banners 10 of all registered advertisers 200 (e.g. calling application display definitions and calling definitions such as available calling hours, etc.), the advertisers' 200 other related details (e.g. name, payment details, etc.), pay per call related information (e.g. updated calling rates, number of click-calls performed for each new RMF of each advertiser etc.).

According to some embodiments of the invention, the communication between the advertiser's terminal 201 and the banners main integration module 100, the communication between the user's terminal 251 an the main banners module 100, and the communication between the banners 10 and the main banners module 100 may be carried out via or more communication networks 500, as illustrated in FIG. 2. For example, the advertiser 200 may enter an Internet website through the Internet network 500 to convert his banners 10′ into enhanced banners using a terminal 201 such as a PC, a laptop or any type of terminal known in the art enabling communication and processing of data.

The terminals 201 and 251 used for communicating the advertiser 200 with the user 250 through a call initiated by the calling application 5 may be different than the terminals 201 and 251 used for communicating with the main banners module 100 and the enhanced banners 10, respectively, using at least one different communication network 501, depending on the system's 1000 definitions and the terminal types available by the advertiser 200. for example, the advertiser 200 may define more than one communication networks and/or terminals 201 available for communicating with the user 250 (e.g. the internet—using VoIP, a wired communication network using a telephone, and/or wireless communication network using a cellular phone as the terminal 201).

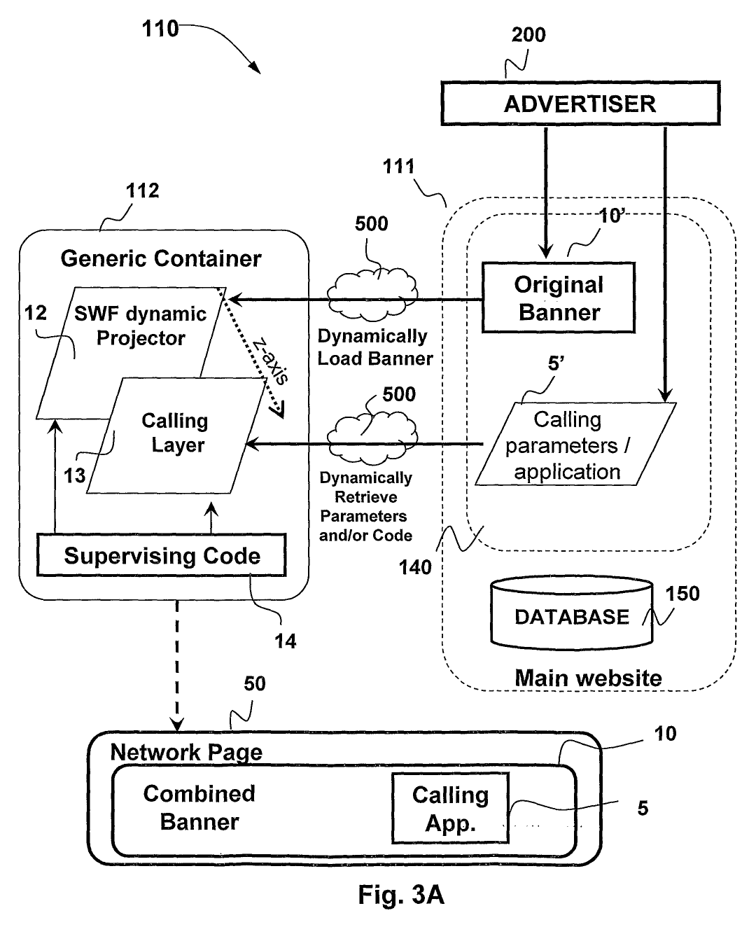

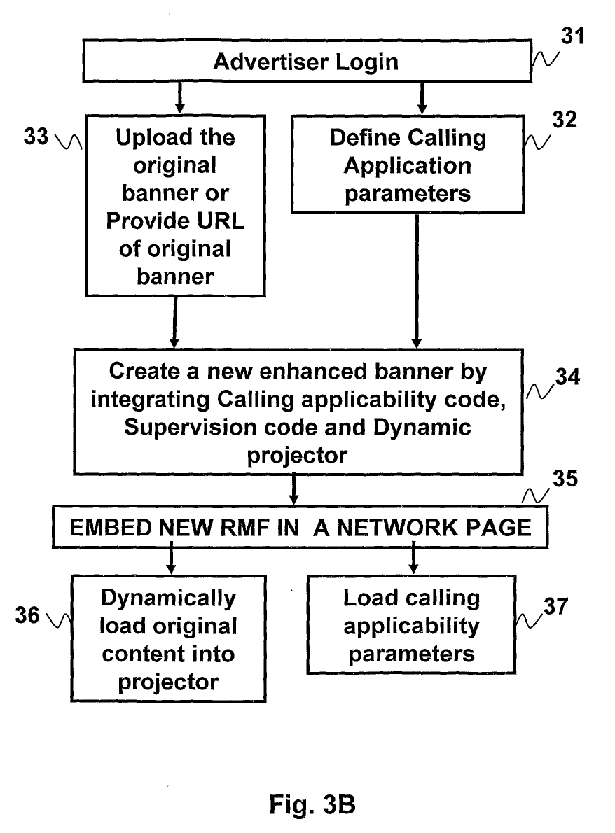

FIG. 3A is a diagram, schematically illustrating an integration module 110 enabling to integrate an original banner 10′ with a calling application code and a supervision code, using a dynamic container 112, according to some embodiments of the invention.

According to these embodiments, the integration module 110 may, make use a generic dynamic container 112, enabling to retrieve and to contain an original banner's code, content and data dynamically loaded from a network page (for example website 111); a website 111, enabling the advertiser 200, to create an enhanced banner 10 by providing content, definitions and code of the original banner 10′, which may be dynamically retrieved by the container 112 based on the provided URL address of the original banner 10′.

The dynamic generic container 112 may comprise a dynamic projector 12 (e.g. a shockwave (SWF) projector); a calling layer 13 (which may display and operate the calling application); and a supervision code 14.

The dynamic projector 12 may enable receiving the location (URL) of the original banner 10′, and some of the banner's 10′ code and projecting the content of the original banner 10′ onto the enhanced banner 10 when the enhanced banner 10 is published in at the network page 50.

The calling layer 13 may be a code for creating the calling application 5 enabling to receive input parameters from the advertiser 200 through the website 111 such as the advertiser's 200 calling details (e.g. phone number(s), IP address etc., graphical features of the interface of the calling application 5 and other calling parameters such as calling conditions). The calling layer 13 may enable dynamically projecting the calling applicability and/or parameters to the calling application 5 in the created enhanced banner 10. Optionally, the calling layer 13 may further enable loading the code of the calling application 5 itself.

FIG. 3B if a flowchart, schematically illustrating a method enabling to integrate code and content of an original banner with a calling application code and with a supervision code, using the dynamic container 112, according to embodiments of FIG. 3A.

According to these embodiments, the method may comprise:

logging into the main website 31

defining the parameters of the calling tool (e.g. carried out manually by the advertiser 200 by inputting the parameters through an interface in the website 111) 32;

Uploading the locator (e.g. URL) of the original banner 10′ and accessing the original banner's 10′ content and code or uploading the original banner 10′ file (e.g. to the website 111) 33;

Creating a new enhanced banner 34 through the container 112;

embedding the new enhanced banner 10 in at least one network page 35 (which may be carried out by an external software and user);

dynamically loading the content of the original banner 10′ from it stored location to the enhanced banner 36 (depending on step 33); while

dynamically loading the calling application and its retrieved parameters to the enhanced banner 37.

The advertiser 200 may register and login to the main website 111 enabling the conversion of original banners 10′ into calling enhanced banners 10. The registration may allow creating a personal account associated with the advertiser 200, where the account may be associated with at least one ID sequence (e.g. password and user name). Once the advertiser 200 enters the account, the advertiser 200 may (1) provide the original banner 10′ by upload or by providing its web location; (2) define the calling parameters or features of the calling application 14 through a designated interface predefined in the website 111, where the system 100 may execute a customization program allowing customizing the parameters of the calling application 14 that will be integrated with the banner 10 (e.g. time frame that the calling application appears, colors, fonts, sizes, defaults, etc). The new RMF enhanced banner 10 container generated may be embedded with a projector 12 which may load original content on-the-fly upon publishing of the enhanced banner 10 at the at least one network page 50 through the network 500. The calling layer 13 may draw and maintain the calling application 14 according to parameters defined by advertiser 200 and may be retrieved on-the-fly through network 500. The system 1000 may further integrate a supervising code 14 in the enhanced banner 10 that may allow managing the code of the original content or its projector 12, calling layer 13 or its placeholder and other related supervision codes (including original content redirections, communications, event handling, z-axis, etc).

In some embodiments of the invention, the enhanced container 10 may also dynamically load at least part of the calling application code 14 at run-time and then execute it to reduce the container file size at impression time at network page 50. Parts or all of the calling application code 13 loading may be done in the same way as the way the original content is loaded into the container 112 (in SWF files, for example, by loading a resource of a compiled SWF file into a movie clip object or sprite, utilizing its URL).

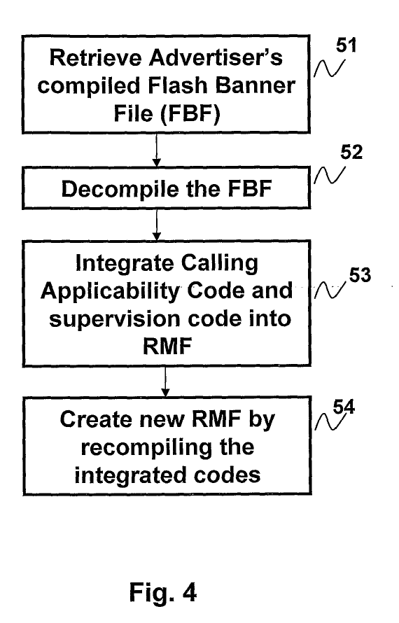

FIG. 4 is a flowchart, schematically illustrating a process by which the integration of the original code of the original banner 10′ may be integrated with a calling application code to create a new RMF enhanced banner 10, by decompiling the original banner and recompiling the integrated codes of the original banner and calling application, according to some embodiments of the invention. According to these embodiments, the process may comprise:
retrieving an original compiled banner 10′ file (e.g. Flash banner file) 51;
decompiling the banner file 52;
integrating the decompiled banner file with (i) the code of the calling application and (ii) with the code enabling to supervise the original content and calling content, display and other functional and operational features 53; recompiling the integrated codes 54, thereby creating a new rich media file.

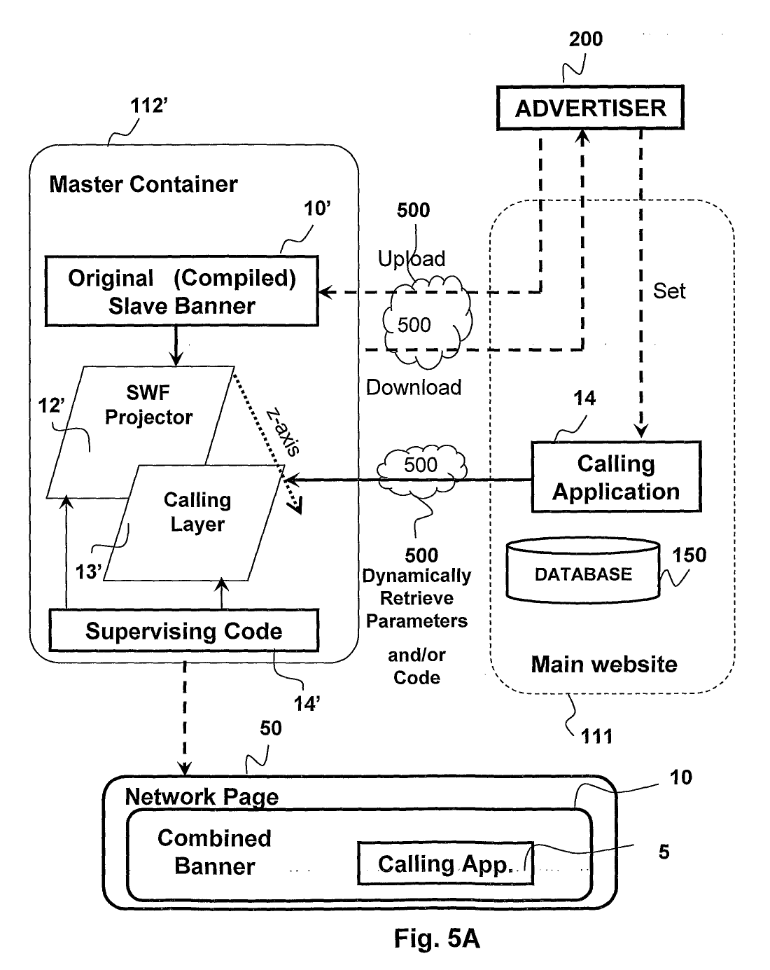

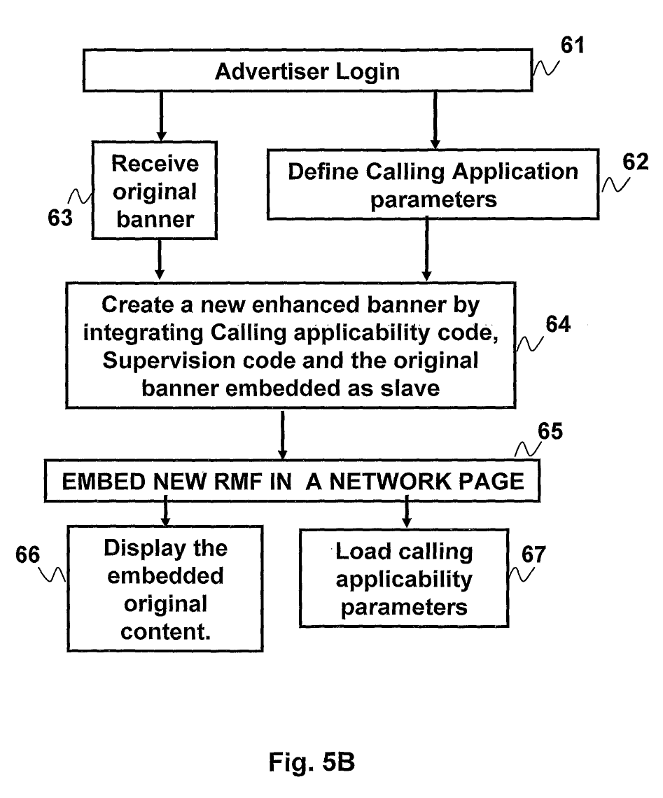

FIG. 5A is a diagram, schematically illustrating an integration module 110 for integrating the original banner 10′ as a slave in a master container 112′, according to other embodiments of the invention. According to these embodiments, the integration module 110 may enable embedding the advertiser's 200 original banner 10′ as a slave in a master container 112′. The master container 112′ may comprise a projector 12′, a call layer 13′ and, optionally, a supervision code 14′.

The projector 12′ may enable receiving the content and code of the original banner 10′ from within the master container 112′ and displaying the content of the original banner 10′ in the enhanced banner 10.

The calling layer 13′ may be a code for creating the calling application 5 enabling to receive input parameters from the advertiser 200 through the website 111 such as the advertiser's 200 calling details (e.g. phone number(s), IP address etc., graphical features of the interface of the calling application 5 and other calling parameters such as calling conditions). The calling layer 13′ may enable dynamically loading the parameters to the calling application 5 in the created enhanced banner 10.

The supervision code 14′ may enable supervising over the content of the original banner 10′.

Additionally, when the container banner 10 is published, the projector 12′ may load the original banner 10′ as an embedded resource of the file, wherein the calling layer 13′ may load its parameters as stored under the advertiser's 200 account in a database 150.

In some embodiments of the invention, the master container 112′ may dynamically load at least part of the calling application code 13′ at run-time and then execute it to reduce the master container file size at impression time at network page 50 (e.g. in SWF files, for example, by loading the calling application as a compiled SWF file into a movie clip object or sprite, utilizing its URL).

FIG. 5B if a flowchart, schematically illustrating a method enabling to integrate code and content of an original banner 10′ with a calling application code and a supervision code, using the master container 112′, according to other embodiments of FIG. 5A.

According to these embodiments, the method may comprise:

logging into the main website 61

defining the parameters of the calling tool (e.g. carried out manually by the advertiser 200 by inputting the parameters through an interface in the website 111) 62;

receiving and embedding the original banner 63 into the master container 112′;

creating a new enhanced banner 64 using a master container 112′;

embedding the new enhanced banner 10 in at least one network page 65 (where the embedding is carried out by an external application and/or distributor);

Displaying the content of the original banner 10′ 66 (which may include loading the content and code 10′ from the master container 112′); while

dynamically loading the calling application and/or its retrieved parameters to the enhanced banner 67.

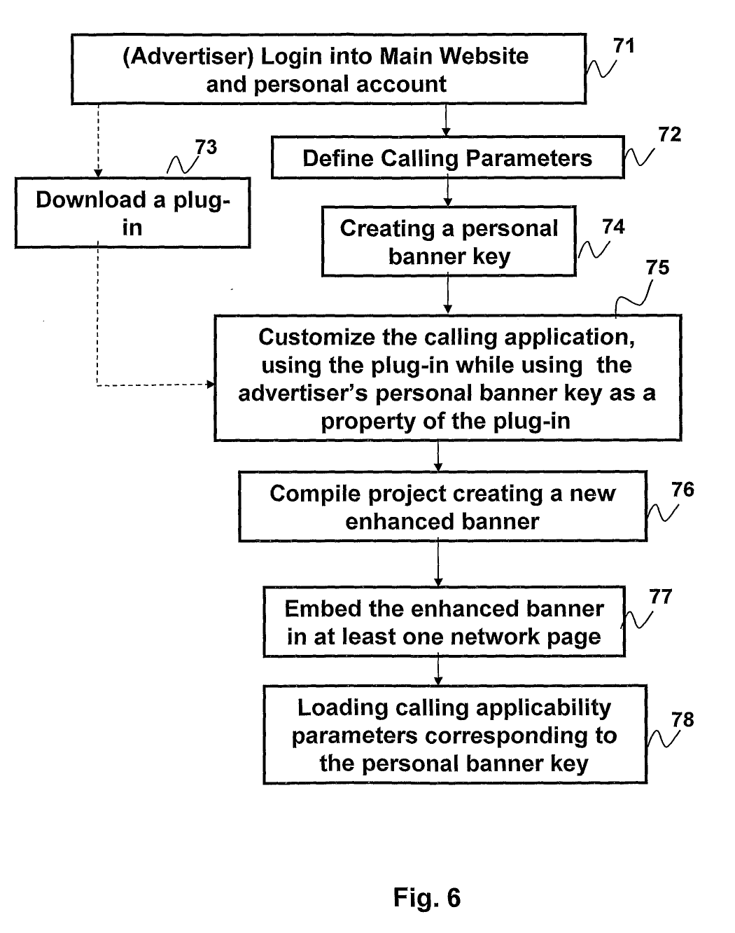

FIG. 6 is a flowchart, schematically illustrating a process for customizing the parameters and functionality of the calling application 5, according to some embodiments of the invention.

According to some embodiments of the invention, as illustrated in FIG. 6, the method for customizing the calling application 5 may comprise:

logging into the main website 111 and into a personal account of the advertiser 71 (where the advertiser 200 carries out the logging);

defining calling parameters 72;

downloading a plug-in software tool 73, enabling a user (such as a graphic designer) to customize the graphical designing and functionality of the calling application of the advertiser 200;

automatically creating a personal key enabling access to all the calling application parameters defined by the advertiser 200 74;

customizing the calling application of the advertiser 75, using the plug-in and providing the plug-in with the advertiser's 200 personal key property to define the properties of the calling application 5 of the advertiser 200;

compiling the project creating a new enhanced banner 76

embedding the enhanced banner 10 in at least one network page 77; and

loading the calling application parameters (originally defined by the advertiser 200) corresponding to the personal key of the advertiser 78.

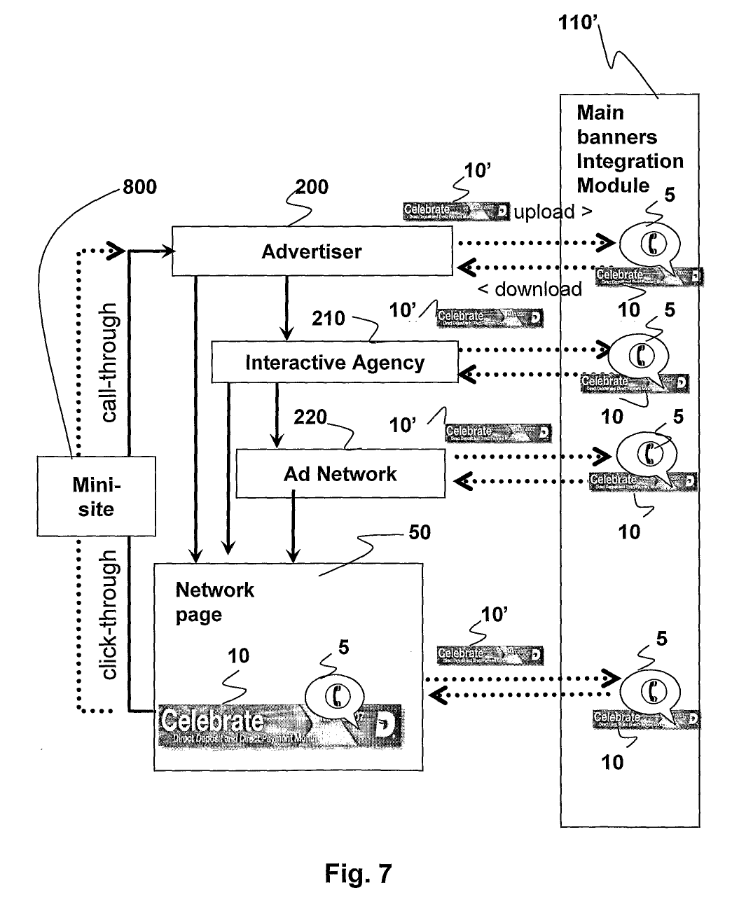

FIG. 7 is a diagram, schematically illustrating a main banners module 110′, enabling to receive multiple original banners 10′ from multiple sources such as the advertiser 200 (using the main website 111 for example, an interactive agency 210, an ad network 220 etc, which may be third party entities that can maintain banners of advertisers 200), integrate them with calling application 5 and return the resulting enhanced banners 10 to the entity that provided the original banner 10′ or sent it to be enhanced by the system 1000, according to some embodiments of the invention.

This may allow a business method enabling: receiving an existing original banner 10′ advertisement from an advertiser 200 or on his behalf (using third party entities such as 210 and/or 220);
integrating each original banner 10′ with a calling application 5 code and a supervision code (using the main banners module 110′);
returning each converted enhanced banner 10 to the advertiser and/or third party entity such as 210 and/or 220 allowing it to publish the enhanced banner 10 in other external websites (network page 50), which may be uninvolved with the integration process; and
generating calls through the enhanced banners 10 which may be in-parallel to the clicks through the banner.
(optionally) redirecting to a mini-site in-parallel to the generating the call (e.g. mini-site 800 or other website).

The parameters of the application may be altered and customized either before and after the enhanced banner was compiled and also before (e.g. in the website 111) and after applying the plug-in and using the personal key that enables accessing the customized parameters when using the plug-in.

Additionally the process may comprise a registration process in which the advertiser 200 provides details to be saved in a database associated with the main banners module 110′ in order to facilitate the call execution and controlling process, including redirection destination phone number(s), a time-frame for each of the phone numbers, means of payment and so on. The outcome of this business process may be a ready-to-be-published enhanced banner 10 that resembles the original banner 10′, but with an added calling functionality 5. The new enhanced banner 10 may offer free calls to consumers' communication terminals or devices when the once the users select the calling function option. The new enhanced banner 10 may display an interface presentation of the calling application 5 (e.g. a call bubble within the banner) with a phone number field and a ‘Call’ button offering a free callback from the advertiser.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. A computer implemented method of creating compiled enhanced rich-media banner files, each comprising content and functionality of an original compiled ad banner file, which is a compiled rich-media file, associated therewith and a calling application enabling users to initiate a call with an advertiser, wherein said advertiser is associated with the original and enhanced rich-media banner files, said method comprising:
integrating the original code and content of said original compiled ad banner with a code of the calling application; and
creating a new compiled enhanced rich-media banner file, enabling the combined operative functioning and content of the calling application and the original banner,
wherein the new created enhanced and compiled rich-media banner file enables a user to initiate a call between the advertiser and the user by operating the calling application in the enhanced rich-media banner file.

2. The method of claim 1, further comprising integrating a supervision code when creating the enhanced rich-media banner file, wherein the supervision code enables supervising over the code of the original ad banner and the way the original code of the original banner is executed by the enhanced rich-media banner file.

3. The method of claim 1, wherein integrating of the code of the original banner with the code of the calling application includes decompiling of the code of the original banner, integrating the calling application code with the code and content of the original banner, and then recompiling the integrated codes to create the compiled enhanced rich-media banner file.

4. The method of claim 1, further comprising:
defining calling application parameters, enabling the advertiser to customize the calling tool;
uploading the original banner to a dynamic projector operated in a dynamic container;
creating the enhanced rich-media banner file by integrating the calling application code, using a calling layer, enabling to dynamically load data and commands related to the calling application to the enhanced rich-media banner file with a dynamic projector, enabling to dynamically load the content of the original banner into the enhanced rich-media banner file.
embedding the created enhanced rich-media banner file in at least one network page;
dynamically loading the content of the original banner into the enhanced rich-media banner file, using the dynamic projector; and
dynamically loading the parameters of the calling application into the enhanced rich-media banner file, using the calling layer.

5. The method of claim 4, further comprising logging into a main website, wherein the main website includes an interface enabling the advertiser to provide the original banner and define the parameters of the calling application, wherein the website is operatively associated with the dynamic container.

6. The method of claim 4, wherein the creation of the enhanced rich-media banner file further includes integrating a supervision code, which is included in the dynamic container, into the enhanced rich-media banner file, wherein the supervision code enables supervising over the code of the original banner and the way the original code of the original banner is executed by the enhanced rich-media banner file.

7. The method of claim 1, further comprising:
defining calling application parameters, enabling the advertiser to customize the calling tool;
accessing the content and code of the original banner, using a master container including a projector, wherein the projector enables loading content and code from a slave original banner, which is embedded in the master container;
creating the enhanced rich-media banner file by integrating the calling application code, using a calling layer, enabling to dynamically load data and commands related to the calling application to the enhanced rich-media banner file with a the original banner embedded as slave, and a projector, enabling to load the slave into the enhanced rich-media banner file;
loading the content of the slave original banner into the enhanced rich-media banner file, using the projector; and
dynamically loading the parameters of the calling application into the enhanced rich-media banner file, using the calling layer.

8. (canceled)

9. The method of claim 7, wherein the creation of the enhanced rich-media banner file further includes integrating a supervision code, which is included in the master container, into the enhanced rich-media banner file, wherein the supervision code enables supervising over the code of the original banner and the way the original code of the original banner is executed by the enhanced rich-media banner file.

10. (canceled)

11. The method of claim 1, further comprising customization plug-in wherein the customization includes:
logging into a personal account, wherein the advertiser logs into his account in a main website;
defining calling parameters for the calling application, which include at least one identifier of the advertiser's terminal for enabling to communicate the user with the terminal; creating a personal banner key that enables accessing all the calling application parameters defined by the advertiser;
downloading a plug-in software tool, enabling the user to apply the plug-in on the banner being made by changing the graphical designing and functionality of the calling application inserted by applying the plug-in and by providing the personal banner key as a plug-in property to enable access to the calling application parameters defined by the advertiser;
creating a new enhanced rich-media banner file by compiling the banner;
embedding the enhanced rich-media banner file in at least one network page; and
loading the calling application parameters corresponding to the personal banner key of the advertiser.

12. (canceled)

13. A main banners module of creating enhanced compiled rich-media banner files, each comprising content and functionality of an original complied ad banner file, which is a compiled rich-media file, and a calling application enabling users to initiate a call with an advertiser, associated with the original and enhanced rich-media banner files, said main banners module comprising an integration module enabling to receive the code and content of an original banner and integrate the original banner with a calling application to create a new enhanced rich-media banner file with calling applicability.

14. The main banners module of claim 13, further comprising:
a customization module enabling the advertiser users to customize the calling application of enhanced rich-media banner files;
a communication module enabling online communication with at least one enhanced rich-media banner file for managing the functionality and content of the enhanced rich-media banner file;
a database enabling to store data and search for information regarding at least one of: the location of the original banner; parameters defining the functionality of the calling application of the enhanced rich-media banner file associated therewith, data relating to the advertiser.
wherein the customization further includes enabling the advertiser to input at least one calling identifier, to define graphical parameters of the calling application and to define functionality parameters and conditions of the calling application.

15. (canceled)

16. (canceled)

17. (canceled)

18. (canceled)

19. (canceled)

20. (canceled)

21. (canceled)

22. (canceled)

23. (canceled)

24. The main banners module of claim 13, wherein the integration module enables integrating the code of the original banner with the code of the calling application by decompiling of the code of the original banner, integrating the calling application code and then recompiling the integrated codes to create the enhanced rich-media banner file.

25. The main banners module of claim 13, wherein the integration module comprises a dynamic container, which includes:
a dynamic projector enabling to dynamically upload the code of the original banner from a remote main website; and
a calling layer, enabling to dynamically retrieve customized parameters of the advertiser's calling application from the website,
wherein the container enables creating an enhanced rich-media banner file, embedding the enhanced rich-media banner file in at least one network page and then dynamically load the content of the original banner to the embedded enhanced rich-media banner file from the location of the original banner, using the dynamic projector, and
wherein the container further enables loading the parameters of the calling application onto the enhanced rich-media banner file, from the website, using the calling layer.

26. The main banners module of claim 25, wherein the dynamic container further comprises a supervision code enabling to integrate the supervision code into the enhanced rich-media banner file, where the supervision code enables supervising over the content of the original banner and the way the original code of the original banner is executed by the enhanced rich-media banner file.

27. The main banners module of claim 13, wherein the integration module comprises a master container, which includes:
at least one original banner, which is a slave banner;
a projector enabling to load the code and content of the original banner from the master container; and
a calling layer, enabling to dynamically retrieve customized parameters of the advertiser's calling application from the website,
wherein the master container enables creating an enhanced rich-media banner file, and, to load the content of the original banner to the enhanced rich-media banner file from the master container, using the projector, once the enhanced rich-media banner file is embedded in at least one network page, and
wherein the container further enables loading at least one of: the parameters of the calling application; at least part of the calling application code, onto the embedded enhanced rich-media banner file, from the website, using the calling layer projector.

28. The main banners module of claim 27, wherein the master container further comprises a supervision code enables supervising over the content of the original banner and the way the original code of the original banner is executed by the enhanced rich-media banner file.

29. The main banners module of claim 13, further enables creating multiple enhanced banners by receiving original banners from at least one third party entity communicating with the main banners module, through at least one communication network, and returning each created enhanced rich-media banner file to the third party entity which transmitted the original banner for enhancing.

30. A system of creating enhanced rich-media banner files, each comprising content and functionality of an original compiled ad banner file, which is a compiled rich-media file, associated therewith and a calling application enabling users to initiate a call with an advertiser, associated with the original and enhanced rich-media banner files, said system comprising:
a main banners module enabling to receive the code and content of an original banner and integrate the original banner with a calling application to create a new enhanced rich-media banner file with calling applicability;
at least one advertiser's terminal, associated with at least one advertiser, enabling to communicate with at least one user, via at least one communication network; and
at least one user's terminal, enabling to communicate with at least one network page where the enhanced rich-media banner files are embedded and with the advertiser's terminal via at least one communication network,
wherein the calling application in the enhanced rich-media banner file created enables communicating the advertiser associated with the rich-media banner file with at least one user through the at least one advertiser's and user's terminals.

31. The system of claim 30, wherein the main banners module comprises:
an integration module enabling to receive the code and content of an original banner and integrate the original banner with a calling application to create a new enhanced rich-media banner file with calling applicability; and
a communication module, enabling to receive data and commands from the enhanced rich-media banner files, to supervise the calling application and to store data on the rich-media banner files;
a database enabling to store data and search for information regarding the original banners of each advertiser, calling application parameters and other details related to each advertiser;
a customization module enabling the advertiser to customize the calling application of enhanced rich-media banner files;
wherein the customization includes enabling the advertiser to input at least one calling identifier enabling to identify the advertiser's terminal for communicating with the user and to initiate a call from the advertiser's terminal to the user, to define graphical parameters of the calling application and to define functionality parameters and conditions of the calling application
wherein online communication with the enhanced rich-media banner file and managing the embedded enhanced rich-media banner files through at least one communication network of at least one type.

32. The system of claim 31, wherein the main banners integration module further enables integrating a supervision code with the original banner and calling application to create the enhanced rich-media banner file, wherein the supervision code enables supervising over the content of the original banner and the way the original code of the original banner is executed by the enhanced rich-media banner file.

33. (canceled)

34. (canceled)

35. (canceled)

36. (canceled)

37. (canceled)

38. (canceled)

39. (canceled)

40. The system of claim 30, wherein the main banners module enables integrating the code of the original banner with the code of the calling application by decompiling of the code of the original banner, integrating the calling application code and then recompiling the integrated codes to create the enhanced rich-media banner file.

41. The system of claim 30, wherein the main banners module comprises a dynamic container, which includes:
a dynamic projector enabling to dynamically upload the code of the original banner from a remote main website; and
a calling layer, enabling to dynamically retrieve customized parameters of at least one of: the advertiser's calling application; at least parts of the calling application code from the website,
wherein the container enables creating an enhanced rich-media banner file and then dynamically load the content of the original banner to the enhanced rich-media banner file, once the banner is embedded in at least one network page, from the location of the original banner, using the dynamic projector, and
wherein the container further enables dynamically loading the parameters of the calling application to the embedded enhanced rich-media banner file, from the website, using the calling layer.

42. The main banners module of claim 41, wherein the container further comprises a supervision code, wherein the container enables integrating the supervision code into the enhanced rich-media banner file, where the supervision code enables supervising over the content of the original and the way the original code of the original banner is executed by the enhanced rich-media banner file.

43. The system of claim 30, wherein the main banners module comprises a master container, which includes:
at least one original banner, which is a slave banner;
a projector enabling to load the code and content of the original banner from the master container; and
a calling layer, enabling to dynamically retrieve at least one of: customized parameters of the advertiser's calling application; at least part of the calling application code, from the website,
wherein the master container enables creating an enhanced rich-media banner file and then dynamically load the content of the original banner to the enhanced rich-media banner file from master container, using the projector, once the enhanced rich-media banner file is embedded in the at least one network page network page, and
wherein the container further enables loading at least one of: the parameters the calling application; at least part of the calling application code onto the embedded enhanced rich-media banner file, from the website, using the calling layer projector.

44. The system of claim 43 wherein the master container further comprises a supervision code, wherein the master container enables integrating the supervision code into the enhanced rich-media banner file, where the supervision code enables supervising over the content of the original banner and the way the original code of the original banner is executed by the enhanced rich-media banner file.
